(19) United States
(12) Patent Application Publication
(10) Pub. No.: US 2017/0357615 A1
(43) Pub. Date: Dec. 14, 2017

(54) FREQUENCY-DOMAIN TO TIME-DOMAIN DATA CONVERSION

(71) Applicant: FUJITSU LIMITED, Kawasaki-shi (JP)

(72) Inventor: Yasuo HIDAKA, Cupertino, CA (US)

(73) Assignee: FUJITSU LIMITED, Kawasaki-shi (JP)

(21) Appl. No.: 15/180,009

(22) Filed: Jun. 11, 2016

(51) Int. Cl. G06F 17/14

(52) U.S. Cl. CPC G06F 17/141

(57) ABSTRACT

A device for converting frequency-domain data to time-domain data may be provided. The device may include one or more processors. The one or more processors may be configured to transform frequency-domain data to a complex conjugate symmetric of the frequency-domain data over an entire range of frequencies while maintaining a maximum frequency. The one or more processors may further be configured to apply an Inverse Discrete Fourier Transform operation to the complex conjugate symmetric of the frequency-domain data to generate time-domain data.

### FIELD

The embodiments discussed herein are related to converting frequency-domain data to time-domain data.

### BACKGROUND

The Fourier Transform converts data from the time-domain to the frequency-domain. Conversion of data from frequency-domain to time-domain is generally defined by the Inverse Fourier Transform.

The subject matter claimed herein is not limited to embodiments that solve any disadvantages or that operate only in environments such as those described above. Rather, this background is only provided to illustrate one example technology area where some embodiments described herein may be practiced.

### SUMMARY

According to an aspect of an embodiment, a device includes one or more processors. The one or more processors may be configured to transform frequency-domain data to a complex conjugate symmetric of the frequency-domain data over an entire range of frequencies while maintaining a maximum frequency. The one or more processors may further be configured to apply an Inverse Discrete Fourier Transform to the complex conjugate symmetric of the frequency-domain data to generate time-domain data.

The object and advantages of the embodiments will be realized and achieved at least by the elements, features, and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1A is a plot depicting frequency-domain data;

FIG. 1B is a plot depicting input data for an Inverse Discrete Fourier Transform operation;

FIG. 1C is a plot depicting time-domain data with non-casual jaggy glitches;

FIG. 2A is a plot depicting frequency-domain data;

FIG. 2B is a plot depicting input data for an Inverse Discrete Fourier Transform operation;

FIG. 2C is a plot depicting time-domain data with non-casual jaggy glitches;

FIG. 3A is a plot illustrating original frequency-domain data and phase adjusted frequency-domain data;

FIB. 3B is a plot illustrating complex conjugate symmetric frequency-domain data for an Inverse Discrete Fourier Transform operation;

FIG. 3C is a plot depicting time-domain data;

FIG. 3D is a plot illustrating time-domain data and phase adjusted time-domain data;

FIG. 4 is a flowchart of an example method for converting frequency-domain data to time-domain data; and

FIG. 5 is a block diagram of an example computing device.

### DESCRIPTION OF EMBODIMENTS

The embodiments discussed herein are related to converting frequency-domain data to time-domain data. In one embodiment, frequency-domain data may be phase adjusted, and the frequency-domain data may be made complex conjugate symmetric. Further, the frequency-domain data may be converted to time-domain data via an Inverse Discrete Fourier Transform. The time-domain data may then be shifted to cancel out the phase adjustment performed in the frequency-domain.

Various embodiments a disclosed herein may have application in, for example only, simulators and/or simulation software (e.g., for high-speed signal transmission system, acoustic systems, seismology, etc.) and measurement equipment (e.g., vector network analyzers, oscilloscope, etc.). Various embodiments disclosed herein may increase simulator accuracy, which may result in improved design quality (e.g., higher performance and/or lower power).

Embodiments of the present invention will be explained with reference to the accompanying drawings.

In order to make converted data in the time-domain real (no imaginary component), the frequency-domain data may be complex conjugate symmetric (e.g., (X(f)=X*(−f)). In Discrete Fourier Transform (DFT) and Inverse Discrete Fourier Transform (I-DFT), because the shared value should be complex conjugate of itself, the maximum positive and maximum negative frequencies share a single real value. Here, maximum negative frequency means the negative frequency with the maximum magnitude. The maximum positive and maximum negative frequencies in DFT and I-DFT correspond to positive infinite and negative infinite frequencies in continuous Fourier Transform (FT) and Inverse Fourier Transform (I-FT). Frequency-domain data converted from time-domain data by DFT always satisfies this condition. Frequency-domain data not converted from time-domain data (e.g. frequency-domain data directly measured by Vector Network Analyzer or frequency-domain data directly simulated by electro-magnetic field simulator in frequency domain) does not generally satisfy this condition.

In order to satisfy the above condition, some conventional methods increase a maximum frequency and add a real value shared by the new maximum positive and negative frequencies. However, this approach results in non-causal jaggy glitches in the time-domain data.

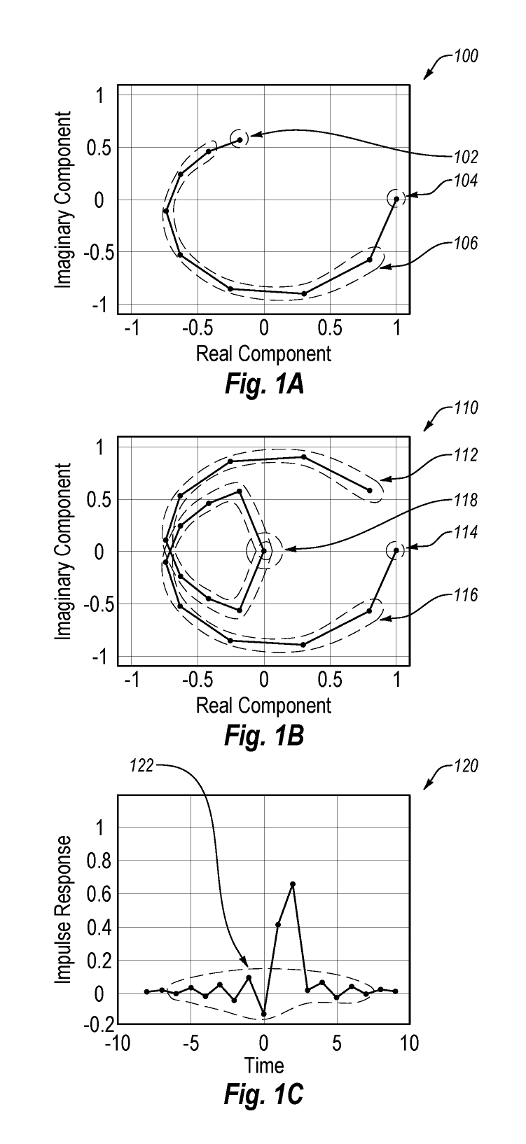

FIGS. 1A-1C illustrate an approach wherein a zero is added as data at the new maximum frequency. FIG. 1A is a plot 100 depicting original frequency-domain data at an original maximum frequency 102, a zero frequency 104, and intermediate frequencies 106. FIG. 1B is a plot 110 of input data for an Inverse Discrete Fourier Transform operation at a negative frequency 112, a zero frequency 114, a positive frequency 116, and a new maximum frequency 118, which is for both positive and negative frequencies. FIG. 1C is a plot 120 depicting time-domain data generated via preforming an Inverse Discrete Fourier Transform operation on the input data shown in plot 110 of FIG. 1B. As illustrated in plot 120, the time-domain data includes non-casual jaggy glitches 122.

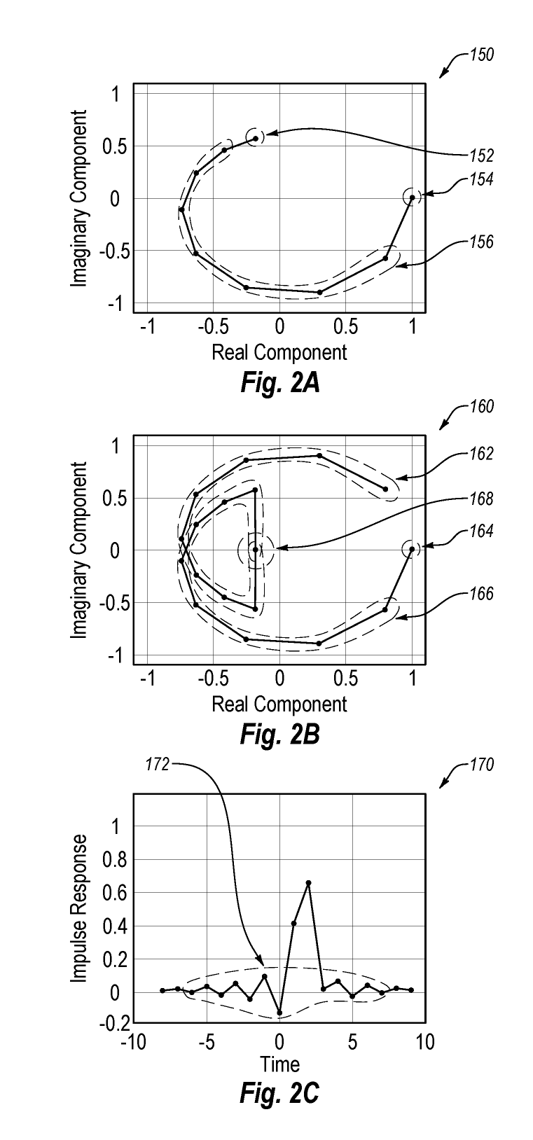

FIGS. 2A-2C illustrate an approach wherein the real component is added at the original maximum frequency as the data at the new maximum frequency. FIG. 2A is a plot 150 depicting original frequency-domain data at an original maximum frequency 152, a zero frequency 154, and intermediate frequencies 156. FIG. 2B is a plot 160 of input data for an Inverse Discrete Fourier Transform operation at a negative frequency 162, a zero frequency 164, a positive frequency 166, and a new maximum frequency 168, which is for both positive and negative frequencies. FIG. 2C is a plot 170 depicting time-domain data generated via preforming an Inverse Discrete Fourier Transform operation on the input data shown in plot 160 of FIG. 2B. As illustrated in plot 170, the time-domain data includes non-casual jaggy glitches 172.

In accordance with various embodiments, a phase of frequency-domain data may be adjusted to align the phase at a maximum frequency to either zero or Pi (e.g., rotate it to real axis) using a continuous-time delay at infinitesimal resolution. As described herein, the phase adjustment performed in the frequency-domain may be cancelled in the time-domain (e.g., after an Inverse Discrete Fourier Transform operation) to revert the effect of the frequency-domain phase adjustment.

More specifically, initially, a phase of the original frequency-domain data may be adjusted by applying a certain continuous-time delay so that the frequency-domain data at the maximum frequency has a real value. In the frequency-domain, a delay is consistent change of phase proportional to frequency. For example, the phase of the original frequency-domain data may be adjusted according to the following equation:

Y(fₖ)=X(fₖ)exp(−j2πfₖτ_{d}); (1)

wherein X(fₖ)ε [symbol] is the original frequency-domain data defined at discrete frequencies fₖ=kΔf, kε{0, 1, . . . , N}. Further, a frequency step Δf=fₘₐₓ/N, the maximum frequency fₘₐₓ=NΔf, and τ_{d} is the delay to be applied. Delay τ_{d}=(∠X(fₘₐₓ)/π+q)Δt, wherein ∠X(fₘₐₓ) is an angle of X(fₘₐₓ) and qε [symbol] is an integer number and Δt is time step given by Δt=½fₘₐₓ. According to one embodiment, 2NΔtΔf=1. Further, Y(fₖ) is the delayed (phase-adjusted) frequency-domain data so that Y(fₘₐₓ) is always real (Y(fₘₐₓ)ε [symbol] ). In addition, the above may be proven by ∠Y(fₘₐₓ)=∠(X(fₘₐₓ)exp(−j2πfₘₐₓτ_{d}))=∠X(fₘₐₓ)−2πNΔf(∠X(fₘₐₓ)/π+q)Δt=−qπ.

Further, the frequency-domain data may be transformed into data that is complex conjugate symmetric of the frequency-domain data without increasing the maximum frequency. In one embodiment, by adding the complex conjugate of data at positive frequencies as data at negative frequencies, the frequency-domain data may be transformed into data that is complex conjugate symmetric of the frequency-domain data without increasing the maximum frequency. Increasing the maximum frequency may not be required due to the data at the original maximum frequency being real, as noted above. Thus, the original maximum frequency is identical to the complex conjugate of itself. The frequency-domain data may be transformed into data that is the complex conjugate symmetric according to the following:

$${Y}_{ccs} ( {f}_{k} ) = \{ \begin{matrix}Y ( {f}_{k} ) & k ∈ \{ 0 , 1 , … , N \} \\ {Y}^{*} ( - {f}_{k} ) & k ∈ \{ - 1 , - 2 , … , - N \}\end{matrix} ; \qquad ( 2 )$$

wherein Y_{ccs}(fₖ) is the complex-conjugate-symmetric form of the delayed frequency-domain data, Y* represents complex conjugate of Y, and Y_{CCS}(−fₘₐₓ)=Y*(fₘₐₓ)=Y(fₘₐₓ)=Y_{ccs}(fₘₐₓ) because ∠Y(fₘₐₓ)=−qπ where qε [symbol] .

In addition, the Inverse Discrete Fourier Transform may be applied to transform the data from frequency-domain to time-domain without increasing the maximum frequency. According to one embodiment, the Inverse Discrete Fourier Transform may be applied to transform the data from frequency-domain to time-domain according to the following:

$$y ( {τ}_{i} ) = \frac{1}{2 N} {\sum }_{k = - N + 1}^{N} {Y}_{ccs} ( {f}_{k} ) exp ( j 2 π {f}_{k} {τ}_{i} ) = \frac{1}{2 N} {\sum }_{k = - N + 1}^{N} {Y}_{ccs} ( {f}_{k} ) exp ( j \frac{2 π ki}{2 N} ) ; \qquad ( 3 )$$

wherein y(τᵢ)ε [symbol] is the delayed time-domain data defined at discrete times τᵢ=iΔt where iε{−N, −N+1, . . . , −1, 0, 1, . . . , N}.

It is noted that Y_{CCS}(−fₘₐₓ) is not used in I-DFT, because it is the same as and shared with Y_{CCS}(fₘₐₓ). Further, y(τ_{-N}) is not necessarily calculated, because it is always the same as y(τ_{N}).

Moreover, the phase adjustment previously performed, may be cancelled by applying a revert continuous-time delay to the time line of the time-domain data. The phase adjustment may be cancelled according to the following:

x(tᵢ)=y(tᵢ+τ_{d})=y(τᵢ−τ_{d}+τ_{d})=y(τᵢ); (4)

wherein x(tᵢ)ε [symbol] is the non-delayed time-domain data defined at discrete times tᵢ=τᵢ−τ_{d}=iΔt−τ_{d}.

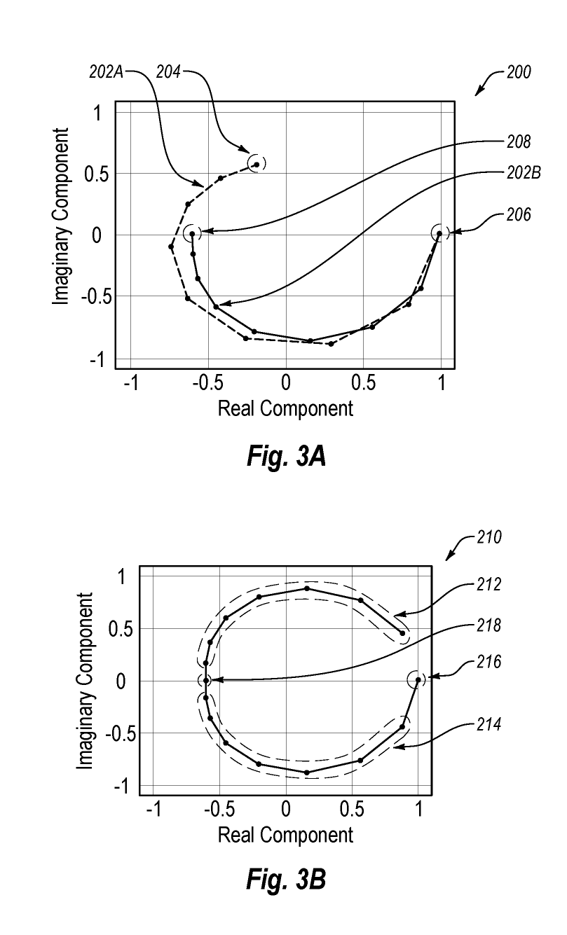

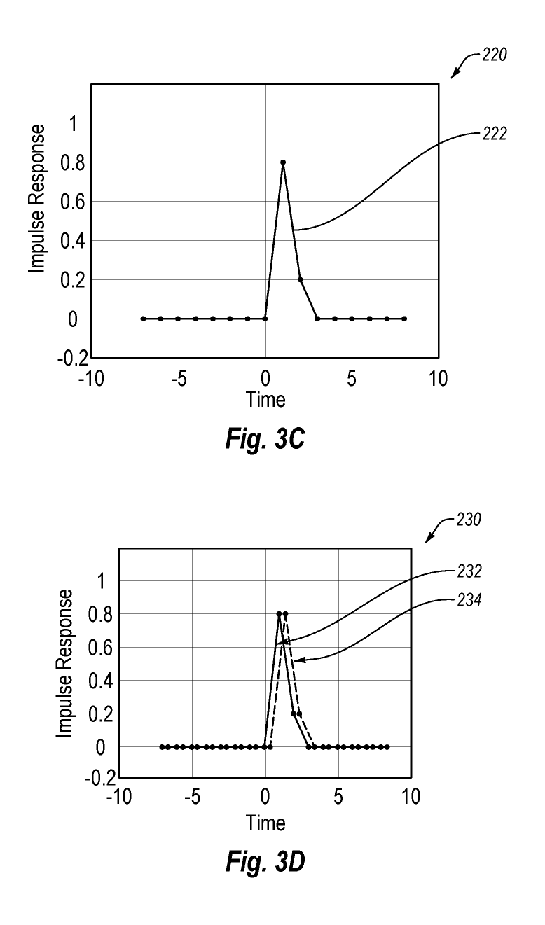

FIGS. 3A-3D are plots related to transforming data from the frequency-domain to the time-domain, according to at least one embodiment. FIG. 3A is a plot 200 including a curve 202A that represents the original frequency-domain data including complex value data at original maximum frequency 204 and a zero frequency 206.

As noted above, a phase of the original frequency-domain data may be adjusted by applying a certain continuous-time delay so that the frequency-domain data at the maximum frequency has a real value. In one embodiment, the continuous time delay may be selected so that the phase of the phase-adjusted frequency-domain at the maximum frequency is an integer multiple of Pi.

Plot 200 further depicts a curve 202B that represents the frequency-domain data after being adjusted via application of a continuous-time delay. As illustrated, curve 202B includes a real value 208 at the maximum frequency.

Further, as previously described, the frequency-domain data may be made complex conjugate symmetric without increasing the maximum frequency. FIG. 3B depicts a plot 210 of input data for an Inverse Discrete Fourier Transform, wherein the frequency-domain data may is complex conjugate symmetric. Plot 210 depicts frequency-domain data at a negative non-maximum frequency 212, a positive non-maximum frequency 214, a zero frequency 216, and a real-value 218 at a maximum frequency (both positive and negative). It is noted that the maximum frequency of the frequency-domain data illustrated in plot 210 has not been increased. FIG. 3C is a plot 220 depicting time-domain data 222 generated via preforming an Inverse Discrete Fourier Transform operation on the input data shown in plot 210 of FIG. 3B.

As noted above, the phase adjustment, as previously performed with regard to FIG. 3A, may be cancelled by applying continuous time delay to the time line of the time-domain data (e.g., to revert the continuous time delay performed in the frequency-domain). FIG. 3D is a plot 230 depicting time-domain data 232 prior to cancelling the phase adjustment, and time-domain data 234 after cancelling the phase adjustment. As illustrated in FIG. 3D, the time-domain data is free from glitches.

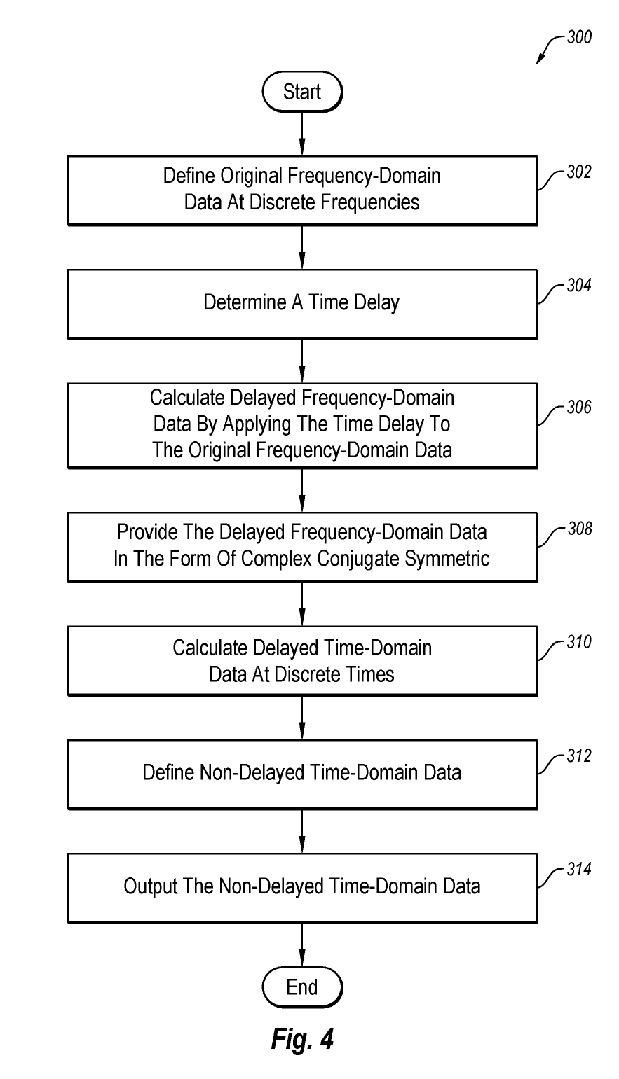

FIG. 4 shows an example flow diagram of a method 300 of converting frequency-domain data to time-domain data, arranged in accordance with at least one embodiment described herein. Although illustrated as discrete blocks, various blocks may be divided into additional blocks, combined into fewer blocks, or eliminated, depending on the desired implementation.

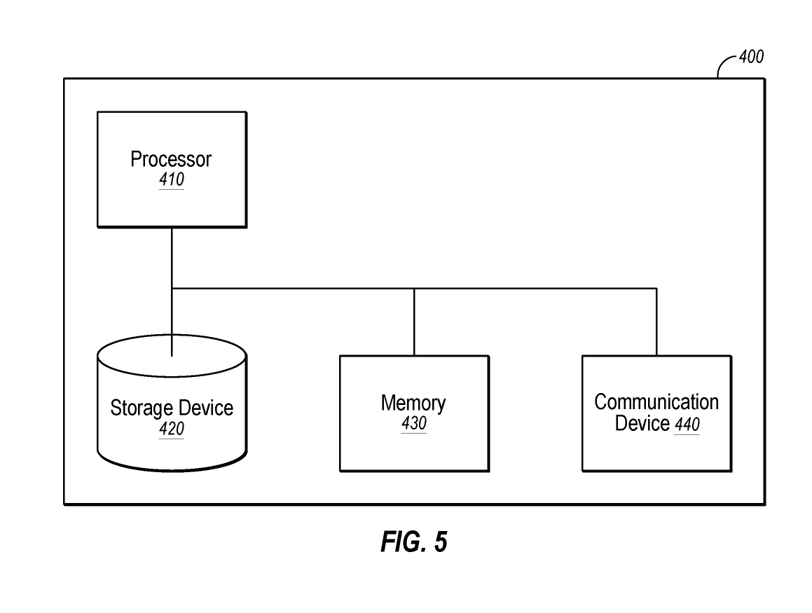

In some embodiments, method 300 may be performed by a system or device, such as computing device 400 of FIG. 5. For instance, processor 410 of computing device 400 (see FIG. 5) may be configured to execute computer instructions stored on memory 430 to perform functions and operations as represented by one or more of the blocks of method 400.

Method 300 may begin at block 302. At block 302, original frequency-domain data may be defined at discrete frequencies, and method 300 may proceed to block 304.

At block 304, a time delay, for adjusting the phase of the original frequency-domain data so that the data at a maximum frequency has a real value, may be determined, and method 300 may proceed to block 306.

At block 306, delayed frequency-domain data may be calculated by applying the time delay to the original frequency-domain data, and method may proceed to block 308.

At block 308, the delayed frequency-domain data may be provided in the form of complex conjugate symmetric, and method 300 may proceed to block 310.

At block 310, delayed time-domain data at discrete times may be calculated by applying the Inverse Discrete Fourier Transform operation to the delayed frequency-domain data in the form of complex conjugate symmetric, and method 300 may proceed to block 312.

At block 312, non-delayed time-domain data may be defined by applying a revert delay of the time delay to the time line, and method 300 may proceed to block 314.

At block 314, the non-delayed time-domain data at discrete times may be outputted.

Modifications, additions, or omissions may be made to method 300 without departing from the scope of the present disclosure. For example, the operations of method 300 may be implemented in differing order. Furthermore, the outlined operations and actions are only provided as examples, and some of the operations and actions may be optional, combined into fewer operations and actions, or expanded into additional operations and actions without detracting from the essence of the disclosed embodiment.

FIG. 5 is a block diagram of an example computing device 400, in accordance with at least one embodiment of the present disclosure. Computing device 400 may include a desktop computer, a laptop computer, a server computer, a tablet computer, an embedded computer, a mobile phone, a smartphone, a personal digital assistant (PDA), an e-reader device, a network switch, a network router, a network hub, other networking devices, or other suitable computing device.

Computing device 400 may include a processor 410, a storage device 420, a memory 430, and a communication component 440. Processor 410, storage device 420, memory 430, and/or communication component 440 may all be communicatively coupled such that each of the components may communicate with the other components. Computing device 400 may perform any of the operations described in the present disclosure.

In general, processor 410 may include any suitable special-purpose or general-purpose computer, computing entity, or processing device including various computer hardware or software modules and may be configured to execute instructions stored on any applicable computer-readable storage media. For example, processor 410 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Although illustrated as a single processor in FIG. 5, processor 410 may include any number of processors configured to perform, individually or collectively, any number of operations described in the present disclosure.

In some embodiments, processor 410 may interpret and/or execute program instructions and/or process data stored in storage device 420, memory 430, or storage device 420 and memory 430. In some embodiments, processor 410 may fetch program instructions from storage device 420 and load the program instructions in memory 430. After the program instructions are loaded into memory 430, processor 410 may execute the program instructions.

For example, in some embodiments one or more of the processing operations of a functional chain may be included in data storage 420 as program instructions. Processor 410 may fetch the program instructions of one or more of the processing operations and may load the program instructions of the processing operations in memory 430. After the program instructions of the processing operations are loaded into memory 430, processor 410 may execute the program instructions such that computing device 400 may implement the operations associated with the processing operations as directed by the program instructions.

Storage device 420 and memory 430 may include computer-readable storage media for carrying or having computer-executable instructions or data structures stored thereon. Such computer-readable storage media may include any available media that may be accessed by a general-purpose or special-purpose computer, such as processor 410. By way of example, and not limitation, such computer-readable storage media may include tangible or non-transitory computer-readable storage media including RAM, ROM, EEPROM, CD-ROM or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 410 to perform a certain operation or group of operations.

In some embodiments, storage device 420 and/or memory 430 may store data associated with converting frequency-domain data to time-domain data. For example, storage device 420 and/or memory 430 may store original frequency-domain data, shifted frequency-domain data, data that is the complex conjugate symmetric of the shifted frequency-domain data, shifted time-domain data, and time-domain data.

Communication component 440 may include any device, system, component, or collection of components configured to allow or facilitate communication between computing device 400 and another device. For example, communication component 440 may include, without limitation, a modem, a network card (wireless or wired), an infrared communication device, an optical communication device, a wireless communication device (such as an antenna), and/or chipset (such as a Bluetooth device, an 802.6 device (e.g. Metropolitan Area Network (MAN)), a Wi-Fi device, a WiMAX device, cellular communication facilities, etc.), and/or the like. Communication component 440 may permit data to be exchanged with any network such as a cellular network, a Wi-Fi network, a MAN, an optical network, etc., to name a few examples, and/or any other devices described in the present disclosure, including remote devices.

In some embodiments, communication component 440 may provide for communication within a network. Communication component 440 may include one or more interfaces. In some embodiments, communication component 440 may include logical distinctions on a single physical component, for example, multiple interfaces across a single physical cable or optical signal.

Modifications, additions, or omissions may be made to FIG. 5 without departing from the scope of the present disclosure. For example, computing device 400 may include more or fewer elements than those illustrated and described in the present disclosure. For example, computing device 400 may include an integrated display device such as a screen of a tablet or mobile phone or may include an external monitor, a projector, a television, or other suitable display device that may be separate from and communicatively coupled to computing device 400.

As used in the present disclosure, the terms “module” or “component” may refer to specific hardware implementations configured to perform the actions of the module or component and/or software objects or software routines that may be stored on and/or executed by general purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated. In the present disclosure, a “computing entity” may be any computing system as previously defined in the present disclosure, or any module or combination of modulates running on a computing system.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

As used herein, the term “data” in plural form may also include the singular form “datum” (e.g., countable noun). Stated another way, for example, the term “data” as used herein may comprise a countable or uncountable noun.

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

All examples and conditional language recited in the present disclosure are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure.

What is claimed is:

1. A device, comprising:
one or more processors configured to:
transform frequency-domain data to a complex conjugate symmetric of the frequency-domain data over an entire range of frequencies while maintaining a maximum frequency; and
apply an Inverse Discrete Fourier Transform to the complex conjugate symmetric of the frequency-domain data to generate time-domain data.

2. The device of claim 1, wherein the one or more processors are further configured to adjust a phase of the frequency-domain data to generate phase-adjusted frequency-domain data prior to transforming the frequency-domain data to the complex conjugate symmetric of the frequency-domain data.

3. The device of claim 2, wherein the one or more processors are further configured to apply a continuous time delay to adjust the phase of the frequency-domain data to generate the phase-adjusted frequency-domain data including a real value at the maximum frequency.

4. The device of claim 3, wherein the continuous time delay is selected so that the phase of the phase-adjusted frequency-domain data at the maximum frequency is an integer multiple of Pi.

5. The device of claim 2, wherein the one or more processors are further configured to align the phase of the frequency-domain data at the maximum frequency to one of zero and Pi to generated the phase-adjusted frequency-domain data.

6. The device of claim 2, wherein the one or more processors are further configured to cancel, in the time-domain, the phase adjustment performed in the frequency-domain.

7. The device of claim 6, wherein the one or more processors are configured to apply a continuous time delay to the time-domain data to cancel the phase adjustment performed in the frequency-domain.

8. The device of claim 1, wherein the one or more processors are configured to apply the Inverse Discrete Fourier Transform to the complex conjugate symmetric of the frequency-domain data to generate the time-domain data while maintaining the maximum frequency.

9. The device of claim 1, wherein the one or more processors are configured to add a complex conjugate of data at positive frequencies as data at negative frequencies to transform the frequency-domain data to a complex conjugate symmetric of the frequency-domain data.

10. A non-transitory computer-readable media having computer instructions stored thereon that are executable by a processing device to perform or control performance of operations comprising:
transforming frequency-domain data to a complex conjugate symmetric of the frequency-domain data over an entire range of frequencies while maintaining a maximum frequency; and
applying an Inverse Discrete Fourier Transform to the complex conjugate symmetric of the frequency-domain data to generate time-domain data.

11. The non-transitory computer-readable media of claim 10, the operations further comprising adjusting a phase of the frequency-domain data to generate a phase-adjusted frequency-domain data prior to transforming the frequency-domain data to the complex conjugate symmetric of the frequency-domain data.

12. The non-transitory computer-readable media of claim 11, wherein the adjusting a phase comprises applying a continuous time delay to adjust the phase of the frequency-domain data to generate the phase-adjusted frequency-domain data including a real value at the maximum frequency.

13. The non-transitory computer-readable media of claim 11, wherein the adjusting a phase comprises aligning the phase of the frequency-domain data at the maximum frequency to one of zero and Pi to generate the phase-adjusted frequency-domain data.

14. The non-transitory computer-readable media of claim 11, the operations further comprising cancelling, in the time-domain, the phase adjustment performed in the frequency-domain.

15. The non-transitory computer-readable media of claim 14, wherein the cancelling comprises applying a continuous time delay to the time-domain data to cancel the phase adjustment performed in the frequency-domain

16. The non-transitory computer-readable media of claim 10, wherein the applying an Inverse Discrete Fourier Transform comprises applying the Inverse Discrete Fourier Transform to the complex conjugate symmetric of the frequency-domain data to generate the time-domain data while maintaining the maximum frequency.

17. The non-transitory computer-readable media of claim 10, wherein the transforming frequency-domain data to a complex conjugate symmetric of the frequency-domain data comprises adding a complex conjugate of data at positive frequencies as data at negative frequencies.

18. A method for converting frequency-domain data to time-domain data, comprising:
transforming frequency-domain data to a complex conjugate symmetric of the frequency-domain data over an entire range of frequencies while maintaining a maximum frequency; and
applying an Inverse Discrete Fourier Transform to the complex conjugate symmetric of the frequency-domain data to generate time-domain data.

19. The method of claim 18, further comprising adjusting a phase of the frequency-domain data to generate phase-adjusted frequency-domain data prior to transforming the frequency-domain data to the complex conjugate symmetric of the frequency-domain data.

20. The method of claim 19, further comprising cancelling, in the time-domain, the phase adjustment performed in the frequency-domain.
